(19) United States
(12) Patent Application Publication
(10) Pub. No.: US 2017/0113520 A1
(43) Pub. Date: Apr. 27, 2017

(54) COMPOSITE GLASS WITH THIN INNER PANE

(71) Applicant: SAINT-GOBAIN GLASS FRANCE, Courbevoie (FR)

(72) Inventors: Sandra SIENERTH, Seevetal (DE); Stephan KREMERS, Heinsberg (DE); Dorothea KETTNER, Aachen (DE); Stefan UEBELACKER, Aachen (DE)

(21) Appl. No.: 15/301,856

(22) PCT Filed: Mar. 9, 2015
(86) PCT No.: PCT/EP2015/054810

§ 371 Date: Oct. 4, 2016

(30) Foreign Application Priority Data
Apr. 15, 2014 (EP) 14164731.3

(51) Int. Cl. B60J 3/00; B60J 1/00; B32B 17/10

(52) U.S. Cl. CPC B60J 3/007; B32B 17/10036; B32B 17/10119; B32B 17/10137; B32B 17/10761; B32B 17/10174; B60J 1/00; B32B 2605/006

(57) ABSTRACT

A vehicle composite glass for separating a vehicle interior from an external environment is presented. The vehicle composite glass has a stack configuration that includes an inner pane made of glass, and outer pane made of glass, and a thermoplastic intermediate layer placed between the two panes bonding the inner pane to the outer pane. In one case, the thickness of the inner pane is 0.1 mm to 0.4 mm and the thickness of the outer pane is 1.0 mm to 1.8 mm.

The invention relates to a composite glass with a thin inner pane, a method for its production, and its use.

Composite glasses are well known as glazings in the automotive sector. They are customarily made of two glass panes with a thickness of 2 mm to 3 mm, which are bonded to each other by means of a thermoplastic intermediate layer. Such composite glasses are, in particular, used as windshields and roof panels, but increasingly also as side windows and rear windows.

The automotive industry is currently endeavoring to reduce the weight of vehicles, which is associated with reduced fuel consumption. A reduction in the weight of glazings, which can be obtained in particular through reduced pane thicknesses, can make a significant contribution to this. Such thin panes have in particular thicknesses less than 2 mm. Despite the reduced pane thicknesses, the requirements for stability and break resistance of the panes must nevertheless be met.

It was previously an accepted view that to ensure adequate stability and break resistance, the two panes of the composite glass must not have less than a certain minimum thickness. US 2013/0295357 A1, for example, discloses a composite glass for vehicles with a thin inner pane. The composite glass consists of an outer pane with a thickness of 1.5 mm to 3.0 mm, for example, 1.6 mm, and a chemically tempered inner pane with a thickness of 0.5 mm to 1.5 mm, for example, 0.7 mm. Composite glasses with thinner inner panes are obviously considered not adequately stable to meet the safety requirements in the automotive sector.

The object of the invention is to provide a composite glass with further reduced thickness and, thus, further reduced weight, which nevertheless has adequate stability and break resistance to be able to be used in the automotive sector.

The object of the present invention is accomplished according to the invention by a composite glass in accordance with claim 1. Preferred embodiments emerge from the subclaims.

The composite glass according to the invention is preferably a composite glass for vehicles (vehicle composite glass). The composite glass is intended, in an opening, in particular a window opening of a vehicle, to separate the interior from the external environment.

The composite glass (or composite pane) according to the invention comprises at least an inner pane, an outer pane, and a thermoplastic intermediate layer, which bonds the inner pane to the outer pane. The inner pane and the outer pane are preferably made of glass.

In the context of the invention, “inner pane” refers to the pane of the composite pane facing the interior (vehicle interior). “Outer pane” refers to the pane facing the external environment.

The outer pane preferably has a thickness of 1.0 mm to 1.8 mm. The inner pane preferably has a thickness of 0.1 mm to 0.4 mm.

In the context of the invention, “inner pane” refers to the pane of the composite pane facing the interior (vehicle interior). “Outer pane” refers to the pane facing the external environment.

It has been found that a composite glass with the thicknesses according to the invention for the outer pane and the inner pane has surprisingly high stability and break resistance, in particular scratch resistance and stone impact resistance. The inner pane can, thus, have a significantly lower thickness than previously generally assumed. The stability and break resistance of the composite glass results from the selection according to the invention of the thickness of the outer pane and the pronounced asymmetry of the outer and the inner pane relative to thickness. Surprisingly, the composite glass according to the invention meets the high safety requirements in the automotive sector. These requirements are typically verified by standardized break, impact, and scratch tests, such as the ball drop test per ECE R43.

The thickness of the inner pane is preferably at most 25% of the thickness of the outer pane, particularly preferably is at most 20%. Such pronounced asymmetry is particularly advantageous with regard to the strength of the pane.

The composite glass according to the invention is particularly preferably a windshield of a motor vehicle.

In a preferred embodiment, the inner pane is a pre-bent pane, i.e., a pane that has been subjected to a thermal bending process prior to the lamination to form the composite glass. To be sure, the inner pane can, in principle, also be a non-pre-bent pane, which, due to its low thickness, adapts to the shape of the outer pane at the time of lamination. However, it is advantageous, particularly in the case of so-called “three-dimensional bends” in multiple spatial directions, to use a pre-bent inner pane because the desired shape can then be obtained with low optical distortions. Since the bending process leaves a characteristic signature in the glass structure, the person skilled in the art can distinguish between a pre-bent and a non-pre-bent pane by visual examination.

According to the invention, the thicker outer pane is pre-bent. The outer pane and the inner pane are preferably pre-bent congruently, in other words, they have the same pre-bending.

The inner pane can, for example, have a thickness of 0.1 mm, 0.2 mm, 0.3 mm, or 0.4 mm. The outer pane can, for example, have a thickness of 1.0 mm, 1.1 mm, 1.2 mm, 1.3 mm, 1.4 mm, 1.5 mm, 1.6 mm, 1.7 mm, or 1.8 mm.

In a particularly advantageous embodiment, the inner pane has a thickness of 0.2 mm to 0.4 mm, preferably of 0.2 mm to 0.3 mm, particularly preferably of approx. 0.3 mm. Thus, particularly good results are obtained with regard to a low weight of the composite glass with high stability and break resistance.

In a particularly advantageous embodiment, the outer pane has a thickness of 1.4 mm to 1.8 mm, preferably of 1.5 mm to 1.7 mm, particularly preferably roughly 1.6 mm. This is particularly advantageous, on the one hand, with regard to a low weight of the composite pane, with the thickness, on the other hand, great enough to ensure adequate asymmetry of thickness between the outer pane and the inner pane, which, in turn, yields high stability.

In an advantageous embodiment of the invention, the outer pane is a non-tempered pane. The outer pane can be exposed to stresses such as stone impact. If a stone, in particular a small sharp stone, strikes a glass pane, it can penetrate its surface. In the case of a tempered pane, the stone can thus penetrate into the tensile stress zone in the pane interior, which results in shattering of the pane. A non-tempered outer pane has a broad compressive stress zone and lower tensile stress in the interior and is thus less susceptible to the impact of a sharp body. Consequently, a non-tempered outer pane is, on the whole, very advantageous with regard to the safety of the vehicle occupants.

In a preferred embodiment of the invention, the outer pane contains soda lime glass or borosilicate glass, in particular soda lime glass. Soda lime glass is economically available and has proven its value for applications in the automotive sector.

In an advantageous embodiment of the invention, the inner pane is a chemically tempered pane. By means of tempering, the inner pane can be provided with special break stability and scratch resistance. For a very thin glass pane, as is intended according to the invention as the inner pane, chemical tempering is better suited than thermal tempering. Since thermal tempering is based on a temperature difference between a surface zone and a core zone, thermal tempering requires a minimum thickness of the glass pane. Adequate stresses can typically be obtained with commercially available thermal tempering systems with glass thicknesses starting from roughly 2.5 mm. With lower glass thicknesses, the generally required values for tempering cannot, as a rule, be obtained (cf., for example, ECE Regulation 43). During chemical tempering, the chemical composition of the glass in the region of the surface is altered by ion exchange, with the ion exchange limited by diffusion to a surface zone. Chemical tempering is, consequently, especially suitable for thin panes. Chemical tempering is also commonly referred to as chemical prestressing, chemical hardening, or chemical strengthening.

The stability of the first pane can be improved by suitable values and local distributions of stresses, which are generated by incorporation of ions during chemical tempering.

The chemically tempered inner pane preferably has a surface compressive stress greater than 100 MPa, preferably greater than 250 MPa, and particularly preferably greater than 350 MPa.

The compressive stress depth of the pane is preferably at least one tenth of its thickness, preferably at least one sixth of its thickness, for example, roughly one fifth of the thickness of the inner pane. This is advantageous with regard to the break resistance of the pane, on the one hand, and a less time-coming tempering process, on the other. In the context of the invention, the term “compressive stress depth” means the depth measured from the surface of the pane to which the pane is under compressive stresses in an amount greater than 0 MPa. If the inner pane has, for example, a thickness of 0.3 mm, the compressive stress depth of the inner pane is preferably greater than 30 μm, particularly preferably greater than 50 μm, most particularly preferably between 100 μm and 150 μm.

The inner pane can, in principle, have any chemical composition known to the person skilled in the art. The inner pane can, for example, contain soda lime glass or borosilicate glass or be made of these glasses. Preferably, the inner pane should be suitable to be chemically tempered, and, in particular, have, for this purpose, a suitable content of alkali elements, preferably sodium. The inner pane can, for example, contain from 40 wt.-% to 90 wt.-% silicon oxide (SiO₂), from 0.5 wt.-% to 10 wt.-% aluminum oxide (Al₂O₃), from 1 wt.-% to 20 wt.-% sodium oxide (Na₂O), from 0.1 wt.-% to 15 wt.-% potassium oxide (K₂O), from 0 wt.-% to 10 wt.-% magnesium oxide (MgO), from 0 wt.-% to 10 wt.-% calcium oxide (CaO), and from 0 wt.-% to 15 wt.-% boron oxide (B₂O₃). The inner pane can, moreover, contain other constituents and impurities.

It has, however, surprisingly been found that certain chemical compositions of the inner pane are particularly suitable to be subjected to chemical tempering. This expresses itself in a high speed of the diffusion process, which results in an advantageously low time outlay for the tempering process, and yields large tempered depths (compressive stress depths), which yields stable and break resistant glasses. In the context of the invention, these compositions are preferred.

The inner pane contains, in a preferred embodiment, an aluminosilicate glass. The inner pane preferably contains from 50 wt.-% to 85 wt.-% silicon oxide (SiO₂), from 3 wt.-% to 10 wt.-% aluminum oxide (Al₂O₃), from 8 wt.-% to 18 wt.-% sodium oxide (Na₂O), from 5 wt.-% to 15 wt.-% potassium oxide (K₂O), from 4 wt.-% to 14 wt.-% magnesium oxide (MgO), from 0 wt.-% to 10 wt.-% calcium oxide (CaO), and from 0 wt.-% to 15 wt.-% boron oxide (B₂O₃). The inner pane can, moreover, contain other constituents and impurities. The inner pane contains particularly preferably at least from 55 wt.-% to 72 wt.-% (most particularly preferably from 57 wt.-% to 65 wt.-%) silicon oxide (SiO₂), from 5 wt.-% to 10 wt.-% (most particularly preferably from 7 wt.-% to 9 wt.-%) aluminum oxide (Al₂O₃), from 10 wt.-% to 15 wt.-% (most particularly preferably from 12 wt.-% to 14 wt.-%) sodium oxide (Na₂O), from 7 wt.-% to 12 wt.-% (most particularly preferably from 8.5 wt.-% to 10.5 wt.-%) potassium oxide (K₂O), and from 6 wt.-% to 11 wt.-% (most particularly preferably from 7.5 wt.-% to 9.5 wt.-%) magnesium oxide (MgO).

These preferred glass compositions have, in addition to the capability of chemical tempering, another surprising advantage. Such panes are suitable to be congruently bent, together with panes of conventional soda lime glass (also referred to as “standard glass”). Similar thermal properties are responsible for this such that the two types of glass are bendable in the same temperature range, i.e., roughly from 450° C. to 700° C. As is sufficiently known to the person skilled in the art, congruently bent panes are particularly suitable due to their optimally matched shape to be bonded to form a composite glass. An inner pane with the preferred chemical compositions is thus particularly suited to be used in a composite glass with an outer pane of a different composition, in particular made of soda lime glass.

However, the inner pane can, alternatively, also be a non-tempered pane. In particular, with very thin glass panes, the stress values that can be obtained through chemical tempering and, thus, the stabilizing effect drop increasingly. If the inner pane is not tempered, it contains, in a preferred embodiment, borosilicate glass. It has been found that with this a particularly pronounced stability and break resistance can be obtained.

The thermoplastic intermediate layer contains at least one thermoplastic film and is, in an advantageous embodiment, formed by a single thermoplastic film. This is advantageous with regard to a simple structure and a low total thickness of the composite glass. The thermoplastic intermediate layer or the thermoplastic film preferably contains at least polyvinyl butyral (PVB), ethylene vinyl acetate (EVA), polyurethane (PU), or mixtures or copolymers or derivatives thereof, which have proved their value for composite glasses.

The thickness of the thermoplastic intermediate layer is preferably from 0.2 mm to 1.0 mm. for example, thermoplastic films of the standard thickness of 0.76 mm can be used.

In a particularly preferred embodiment, the composite glass has no other panes or polymeric layers, thus consists of only the outer pane, the inner pane, and the thermoplastic intermediate layer.

The outer pane, the inner pane, and the thermoplastic intermediate layer can be clear and colorless, but can also be tinted or colored. The total transmittance through the composite glass is, in a preferred embodiment, greater than 70%, in particular when the composite glass is a windshield. The term “total transmittance” refers to the method of testing the light transmittance of motor vehicle window panes established by ECE-R 43, Annex 3, §9.1.

The composite glass is preferably bent in one or in a plurality of spatial directions as is customary for motor vehicle panes, with typical radii of curvature being in the range from roughly 10 cm to roughly 40 m. The composite glass can, however, also be flat, for example, when it is provided as a pane for buses, trains, or tractors.

The composite glass according to the invention can have a functional coating, for example, an IR reflecting or absorbing coating, a UV reflecting or absorbing coating, a coloring coating, a low emissivity coating, a heatable coating, a coating with antenna function, a splinter-binding coating, or a coating for shielding against electromagnetic radiation. The functional coating is preferably arranged on the outer pane. The thicker outer pane, which, in addition, is preferably made of ordinary glass, can be coated in a technically simpler manner and more economically, for example, by physical vapor deposition (such as sputtering) than the very thin inner pane. In particular, coating and chemical tempering can be combined only with great difficulty from a technical standpoint. A coating applied before tempering interferes with the ion diffusion process during chemical tempering. Due to the typically high temperatures, coating after chemical tempering alters the stress distribution in the pane. The functional coating is preferably arranged on the surface of the outer pane facing the thermoplastic intermediate layer, where it is protected from corrosion and damage.

The composite glass can also be provided with an additional function, in that, in addition to or alternatively to the functional coating, the intermediate layer has functional inclusions, for example, inclusions with IR absorbing, UV absorbing, coloring, or acoustic properties. The inclusions are, for example, organic or inorganic ions, compounds, aggregates, molecules, crystals, pigments, or dyes.

The invention is further accomplished by a method for producing a composite glass according to the invention, wherein

(a) the inner pane, the thermoplastic intermediate layer, and the outer pane are arranged in this order one above another in a planar manner, and
(b) the inner pane and the outer pane are bonded to each other by lamination.

If the composite glass is to be bent, at least the outer pane is subjected to a bending process before lamination.

In an embodiment of the invention, the inner pane is not pre-bent. Due to its very low thickness, the inner pane has filmlike flexibility and can thus be adapted to the pre-bent outer pane without having to be pre-bent itself. The production of the composite glass is thus simplified.

In an alternative embodiment, the inner pane is also subjected to a bending process. This is advantageous in particular with sharp bends in multiple spatial directions (so-called “three-dimensional bends).

The outer pane and the inner pane can be bent individually. Preferably, the outer pane and the inner pane are congruently bent jointly (i.e., simultaneously and by the same tool), since, thus, the shape of the panes is optimally matched to each other for the subsequent lamination. Typical temperatures for glass bending processes are, for example, 500° C. to 700° C.

In a preferred embodiment, the inner pane is provided with chemical tempering. Optionally, after bending, the inner pane is slowly cooled. Excessively rapid cooling creates thermal stresses in the pane that can result in shape changes during the subsequent chemical tempering. The cooling rate is preferably from 0.05° C./sec to 0.5° C./sec until cooling to a temperature of 400° C., particularly preferably from 0.1-0.3° C./sec. By means of such slow cooling, thermal stresses in the glass which result in particular in optical defects as well as in a negative impact on the subsequent chemical tempering can be prevented. Thereafter, it can be further cooled even at higher cooling rates, because below 400° C., the risk of generating thermal stresses is low.

The chemical tempering is preferably done at a temperature of 300° C. to 600° C., particularly preferably 400° C. to 500° C. The inner pane is treated with a salt melt, for example, immersed in the salt melt. During the treatment, in particular, sodium ions of the glass are exchanged for larger ions, in particular larger alkali ions, creating the desired surface compressive stresses. The salt melt is preferably the melt of a potassium salt, particularly preferably potassium nitrate (KNO₃) or potassium sulfate (KSO₄), most particularly preferably potassium nitrate (KNO₃).

The ion exchange is determined by the diffusion of the alkali ions. The desired values for the surface compressive stresses and the compressive stress depths can consequently be adjusted in particular by the temperature and the duration of the tempering process. Customary times for the duration are from 2 hours to 48 hours.

After the treatment with the salt melt, the pane is cooled to room temperature. Then, the pane is cleaned, preferably with sulfuric acid (H₂SO₄).

The thermoplastic intermediate layer is preferably provided as a film. The production of the composite glass by lamination is done with conventional methods known per se to the person skilled in the art, for example, autoclave methods, vacuum bag methods, vacuum ring methods, calender methods, vacuum laminators, or combinations thereof. The bonding of the outer pane and the inner pane is customarily done under the action of heat, vacuum, and/or pressure.

The invention further comprises the use of a composite pane according to the invention in a vehicle, preferably a motor vehicle, particularly preferably an automobile, in particular as a windshield, side window, rear window, or roof panel.

In the following, the invention is explained in detail with reference to drawings and exemplary embodiments. The drawings are schematic representations and not true to scale.

The drawings in no way restrict the invention.

They depict:

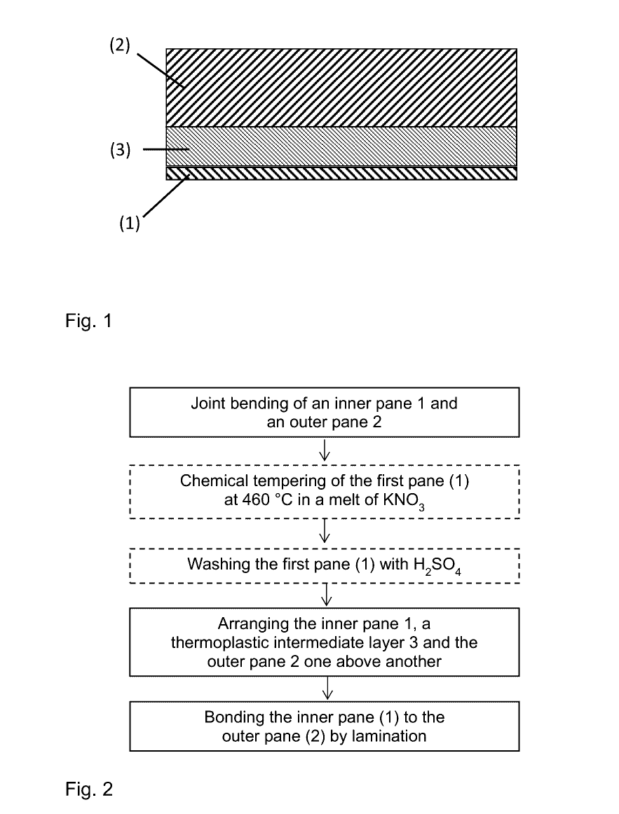

FIG. 1 a cross-section through an embodiment of the composite glass according to the invention and

FIG. 2 a flowchart of an embodiment of the method according to the invention.

FIG. 1 depicts a composite glass according to the invention, which is made of an inner pane 1 and an outer pane 2, which are bonded to each other via a thermoplastic intermediate layer 3. The intermediate layer 3 formed from a single film made of PVB with a thickness of 0.76 mm. The composite glass is intended as a windshield of a motor vehicle. The composite glass is, as customary for motor vehicle windshields, three dimensionally curved. This means that the pane has curvature in multiple spatial directions, in particular in a horizontal and vertical direction. However, for the sake of simplicity, the composite glass is schematically depicted flat in the figure.

The thickness, the glass material, and the tempering of the inner pane 1 and of the outer pane 2 for a composite glass according to the invention (Example) are summarized in Table 1.

The stability of the composite glass according to the invention was evaluated by standardized tests, with the results being compared to those of a composite glass with conventional thicknesses (Comparative Example, cf. Table 1).

TABLE 1

| | Example | Comparative Example |
|---|---|---|
| Inner pane 1 | | |
| Thickness | 0.3 mm | 1.6 mm |
| Material | aluminosilicate glass | soda lime glass |
| | (60.7 wt.-% SiO₂; 7.7 wt.-% | |
| | Al₂O₃, 13.1 wt.-% Na₂O, 9.6 | |
| | wt.-% K₂O, 8.4 wt.-% MgO) | |
| Tempering | chemically tempered | non-tempered |
| Outer pane 2 | | |
| Thickness | 1.6 mm | 2.1 mm |
| Material | soda lime glass | soda lime glass |
| Tempering | non-tempered | non-tempered |

### Stability Against Stone Impact (Sharp Stone)

A projectile with a diamond point was dropped from increasing height onto the composite glass according to the invention (Example), to simulate the impact of a sharp stone. The height at which the composite glass broke was measured. Glass breakage was observed with impact on the outer pane 2 from a height of 1400 mm. The composite glass according to the invention with the very low glass thicknesses surprisingly had higher stone impact resistance than the conventional Comparative Example (glass breakage from a height of 1100 mm).

### Ball Drop Test Per ECE R43

The tests were performed on a 30 cm×30 cm specimen. In the first test, a steel ball with a weight of 227 g was dropped from a height of 8.5 m onto the outer pane 2. This test simulates the impact of a stone from the outside on the composite glass. The test was considered passed when the ball was stopped by the composite glass and did not penetrate it and when the quantity of splinters given off on the side facing away from the impact was less than a specific (thickness-dependent) quantity. The Comparative Example with a glass combination proven for windshields passed the test as expected. However, the composite glass per Example with the low glass thicknesses also, surprisingly, passed the test. Even fewer splinters were given off by the inner pane 1 upon impact of the ball, which must be evaluated as advantageous for the safety of the vehicle occupants.

In the second test, a steel ball with a weight of 2260 g was dropped from a height of 4 m onto the inner pane 1. This test simulates the of a vehicle occupant on the composite glass. The test was considered passed when the ball was stopped by the composite glass and did not penetrate it within 5 s after the break. The Comparative Example with the high glass thicknesses passed the test as expected. However, the composite glass according to the invention per Example with the low glass thicknesses also passed the test.

The composite glass according to the invention has, due to the very low glass thicknesses, a very low weight. However, as the tests demonstrated, the composite glass is nevertheless distinguished by high break resistance and stone impact resistance. The composite glass meets, in particular, the high safety requirements for composite glasses in the automotive sector such that, for example, it can be used as a windshield. It is, in particular, possible to use an extremely thin inner pane for motor vehicle windows. This result was unexpected and surprising for the person skilled in the art.

Alternatively, the inner pane 1 can, for example, also be made of non-tempered borosilicate glass. It was demonstrated that even with such a glass combination (outer pane 1.6 mm, non-tempered soda lime glass; intermediate layer 0.76 mm PVB; inner pane 0.3 mm non-tempered borosilicate glass) very good results can be obtained with regard to stability and break resistance.

FIG. 2 depicts a flowchart of an embodiment of the method according to the invention for producing a composite glass according to the invention. An inner pane 1 and an outer pane 2 are provided in a flat starting state. The inner pane 1 and the outer pane 2 are subjected together to a bending process and congruently bent into their final three-dimensional shape.

Optionally, the inner pane 1 is chemically tempered after bending. To that end, the inner pane 1 is cooled slowly after bending in order to avoid thermal stresses. A suitable cooling rate is, for example, 0.1° C./sec. The inner pane 1 is subsequently treated for a period of a few hours, for example, 4 hours, at a temperature of 460° C. with a melt of potassium nitrate and chemically tempered thereby. The treatment effects a diffusion-driven exchange of sodium ions by larger potassium ions via the surface of the glass. Surface compressive stresses were thus generated. The inner pane 1 is subsequently cooled and then washed with sulfuric acid to remove residues of the potassium nitrate.

Subsequently, a thermoplastic intermediate layer 3 is arranged between the inner pane 1 and the outer pane 2. The stack made up of inner pane 1, intermediate layer 3, and outer pane 2 is bonded in a conventional manner by lamination, for example, by a vacuum bag method.

### LIST OF REFERENCE CHARACTERS

(1) inner pane

(2) outer pane

(3) intermediate layer

1-15. (canceled)

16. A vehicle composite glass for separating a vehicle interior from an external environment, the vehicle composite glass comprising:
an inner pane made of glass with a thickness of 0.1 mm to 0.4 mm;
an outer pane made of glass with a thickness of 1.0 mm to 1.8 mm; and
a thermoplastic intermediate layer, which bonds the inner pane to the outer pane, wherein the thickness of the inner pane is at most 25% of the thickness of the outer pane.

17. The vehicle composite glass according to claim 16, wherein the vehicle composite glass is a windshield.

18. The vehicle composite glass according to claim 16, wherein the inner pane is a pre-bent pane.

19. The vehicle composite glass according to claim 16, wherein the inner pane is a chemically tempered pane.

20. The vehicle composite glass according to claim 19, wherein the inner pane contains aluminosilicate glass.

21. The vehicle composite glass according to claim 16, wherein the inner pane is a non-tempered pane and contains borosilicate glass.

22. The vehicle composite glass according to claim 16, wherein the inner pane has a thickness of 0.2 mm to 0.4 mm.

23. The vehicle composite glass according to claim 16, wherein the outer pane has a thickness of 1.4 mm to 1.8 mm.

24. The vehicle composite glass according to claim 16, wherein the outer pane is a non-tempered pane.

25. The vehicle composite glass according to claim 16, wherein the intermediate layer is formed by a single thermoplastic film with a thickness of 0.2 mm to 1 mm.

26. The vehicle composite glass according to claim 16, wherein:
a surface of the outer pane facing the intermediate layer is provided with a functional coating, or
the intermediate layer has functional inclusions with IR absorbing, UV absorbing, coloring or acoustic properties, preferably organic or inorganic ions, compounds, aggregates, molecules, crystals, pigments, or dyes.

27. The vehicle composite glass according to claim 19, wherein the inner pane contains from 55 wt.-% to 72 wt.-% silicon oxide (SiO₂), from 5 wt.-% to 10 wt.-% aluminum oxide (Al₂O₃), from 10 wt.-% to 15 wt.-% sodium oxide (Na₂O), from 7 wt.-% to 12 wt.-% potassium oxide (K₂O), and from 6 wt.-% to 11 wt.-% magnesium oxide (MgO).

28. The vehicle composite glass according to claim 16, wherein the inner pane has a thickness approximately equal to 0.3 mm.

29. The vehicle composite glass according to claim 16, wherein the outer pane has a thickness of 1.5 mm to 1.7 mm.

30. The vehicle composite glass according to claim 16, wherein the outer pane has a thickness approximately equal to 1.6 mm.

31. The vehicle composite glass according to claim 24, wherein the outer pane contains soda lime glass.

32. The vehicle composite glass according to claim 25, wherein the single thermoplastic film contains at least one or more of: a) polyvinyl butyral (PVB), b) ethylene vinyl acetate (EVA), c) polyurethane (PU), and d) mixtures or copolymers or derivatives thereof.

33. The vehicle composite glass according to claim 26, wherein the functional coating is one of: a) an IR reflecting or absorbing coating, b) a UV reflecting or absorbing coating, c) a coloring coating, d) a low emissivity coating, e) a heatable coating, f) a coating with antenna function, g) a splinter-binding coating, and h) a coating for shielding against electromagnetic radiation.

34. A method for producing a vehicle composite glass according to claim 1, wherein:
the inner pane, the thermoplastic intermediate layer, and the outer pane are arranged, respectively, first, second and third, one above another in a planar manner, and
the inner pane and the outer pane are bonded to each other by lamination, the vehicle composite glass comprising:
the inner pane made, of glass, with a thickness of 0.1 mm to 0.4 mm;
the outer pane, made of glass, with a thickness of 1.0 mm to 1.8 mm; and
the thermoplastic intermediate layer, which bonds the inner pane to the outer pane.

35. The method according to claim 34, wherein the inner pane and the outer pane are jointly bent.

36. The method according to claim 34, wherein the inner pane is chemically tempered in a bent state.

37. A method, comprising using of the vehicle composite glass according to claim 16 in one or more of: a) a motor vehicle, b) an automobile, c) a windshield, d) a side window, e) a rear window, and f) a roof panel.
